(19) United States
(12) Patent Application Publication
(10) Pub. No.: US 2025/0379797 A1
(43) Pub. Date: Dec. 11, 2025

(54) EXITING A MACHINE LEARNING MODEL BASED ON OBSERVED ATYPICAL DATA

(71) Applicant: QUALCOMM Incorporated, San Diego, CA (US)

(72) Inventors: Mahmoud TAHERZADEH BOROUJENI, San Diego, CA (US); Tao LUO, San Diego, CA (US); Mohamed Fouad Ahmed MARZBAN, San Diego, CA (US); Taesang YOO, San Diego, CA (US); Hamed PEZESHKI, San Diego, CA (US); Qiaoyu LI, Beijing (CN)

(21) Appl. No.: 18/875,665

(22) PCT Filed: Aug. 12, 2022
(86) PCT No.: PCT/CN2022/111992

§ 371 Date: Dec. 16, 2024

(51) Int. Cl. H04L 41/16; G06N 3/045; G06N 3/0475; G06N 3/08; H04W 24/02

(52) U.S. Cl. CPC H04L 41/16; G06N 3/045; G06N 3/0475; G06N 3/08; H04W 24/02

(57) ABSTRACT

Techniques and systems are provided for wireless communications. In some examples, a system receives input data for use by a first machine learning (ML) engine to generate an output result. The system may also receive information associated with a first set of training data for the first ML engine. The system may further determine a first dissimilarity amount between the received input data and the first set of training data based on the received information associated with the first set of training data. The system may also determine whether to continue using the first ML engine to generate the output result based on a comparison of the determined first dissimilarity amount to a first dissimilarity threshold.

### CROSS-REFERENCE TO RELATED APPLICATIONS

This application for Patent is a 371 of international Patent Application PCT/CN2022/111992, filed Aug. 12, 2022, which is hereby incorporated by referenced in its entirety and for all purposes.

### FIELD

The present disclosure generally relates to machine learning (ML) systems. For example, aspects of the present disclosure relate to systems and techniques for exiting (e.g., stopping use of) an ML model based on observed atypical data.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Artificial intelligence (AI) and ML based algorithms may be incorporated into the 5G and future standards to improve telecommunications and data services.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for controlling the use of AI/ML-based models (which may be referred to as just ML models) based on a similarity of the input data to data used to train the ML model. For instance, according to various aspects described herein, the systems and techniques may include determining a similarity and/or dissimilarity measurement between the input data and the data used to train the ML model. Use of the ML model may be stopped (or exited) based on a comparison of the similarity and/or dissimilarity measurement and a threshold value.

In one illustrative example, an apparatus for wireless communications is provided that includes at least one memory and at least one processor (e.g., implemented in circuitry) coupled to the at least one memory and configured to: receive input data for use by a first machine learning (ML) engine to generate an output result. The at least one processor is further configured to receive information associated with a first set of training data for the first ML engine. The at least one processor is also configured to determine a first dissimilarity amount between the received input data and the first set of training data based on the received information associated with the first set of training data. The at least one processor is further configured to determine whether to continue using the first ML engine to generate the output result based on a comparison of the determined first dissimilarity amount to a first dissimilarity threshold.

In another example, a method for wireless communications is provided. The method includes receiving input data for use by a first machine learning (ML) engine to generate an output result. The method also includes receiving information associated with a first set of training data for the first ML engine. The method further includes determining a first dissimilarity amount between the received input data and the first set of training data based on the received information associated with the first set of training data. The method also includes determining whether to continue using the first ML engine to generate the output result based on a comparison of the determined first dissimilarity amount to a first dissimilarity threshold.

In another example, a non-transitory computer-readable storage medium comprising instructions stored thereon which, when executed by at least one processor, causes the at least one processor to receive input data for use by a first machine learning (ML) engine to generate an output result. The instructions further cause the at least one processor to receive information associated with a first set of training data for the first ML engine. The instructions also cause the at least one processor to determine a first dissimilarity amount between the received input data and the first set of training data based on the received information associated with the first set of training data. The instructions further cause the at least one processor to determine whether to continue using the first ML engine to generate the output result based on a comparison of the determined first dissimilarity amount to a first dissimilarity threshold.

In another example, an apparatus for wireless communications is provided. The apparatus includes: means for receiving input data for use by a first machine learning (ML) engine to generate an output result; means for receiving information associated with a first set of training data for the first ML engine; means for determining a first dissimilarity amount between the received input data and the first set of training data based on the received information associated with the first set of training data; and means for determining whether to continue using the first ML engine to generate the output result based on a comparison of the determined first dissimilarity amount to a first dissimilarity threshold.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 illustrates an example architecture of a neural network that may be used in accordance with some aspects of the present disclosure;

FIG. 6 is a block diagram illustrating an ML engine, in accordance with aspects of the present disclosure;

FIG. 7 is a block diagram illustrating a technique for exiting a first ML model based on observed atypical data, in accordance with aspects of the present disclosure;

FIG. 8 is a flow diagram illustrating a process for exiting a first ML model based on observed atypical data, in accordance with aspects of the present disclosure; and

FIG. 9 is a diagram illustrating an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Various techniques are provided in reference with wireless technologies (e.g., The 3rd Generation Partnership Project (3GPP) 5G/New Radio (NR) Standard) to provide improvements to wireless communications. One example of such a technique is the application of AI/ML based algorithms to improve aspects of wireless communications. As an example, wireless communications may use discontinuous reception (DRX). In some cases, DRX may include an active state (e.g., on duration) and a sleep state (e.g., off sleep). In the active state, a user equipment (UE) or terminal monitors a downlink channel (e.g., a Physical Downlink Control Channel (PDCCH)) and receives corresponding data (e.g., on a Physical Downlink Shared Channel (PDSCH)). In the sleep state, the UE or terminal closes (e.g., powers down) a receiving unit and no longer monitors the downlink channel (e.g., the PDCCH), so as to achieve energy savings. In some cases, a wireless network may determine when the UE or terminal may enter the sleep state and the wireless network may transmit an indication of such a determination to the UE or terminal via a wireless device, such as a wireless node. In other cases, the UE or terminal may determine when the UE or terminal may enter the sleep state. In some cases, an AI/ML algorithm may be used to determine when the UE or terminal may enter the sleep state. In some cases, it may be desirable to stop using the AI/ML algorithm and in some cases change to, for example, a legacy technique for determining when the UE or terminal may enter the sleep state. While techniques for exiting an ML model based on observed atypical data are described here in conjunction with wireless technologies, it should be understood that such techniques are not intended to be limited in application to wireless technologies, but may be applied to other technologies that utilize ML models.

Systems, apparatuses, electronic devices, methods (also referred to as processes), and computer-readable media (collectively referred to herein as “systems and techniques”) are described herein for providing a technique to determine, based on data to be input to an ML (referred to as input data) model during inference of the ML model (after the ML model has been trained), when to stop using (or to exit) the ML model. In some cases, based on determining to stop using (or to exit) the ML model, the systems and techniques may revert to, for example, a non-ML based algorithm or possibly a different ML model. In some aspects, the systems and techniques may determine a similarity and/or dissimilarity measurement between the input data and data used to train the ML model. The systems and techniques may compare the similarity and/or dissimilarity measurement to a threshold value, and based on the comparison, may determine to stop using (or to exit) the ML model.

Additional aspects of the present disclosure are described in more detail below.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a 3GPP gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

In some aspects, wireless communications networks may be implemented using one or more modulation schemes. For example, a wireless communication network may be implemented using a quadrature amplitude modulation (QAM) scheme such as 16QAM, 32QAM, 64QAM, etc.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

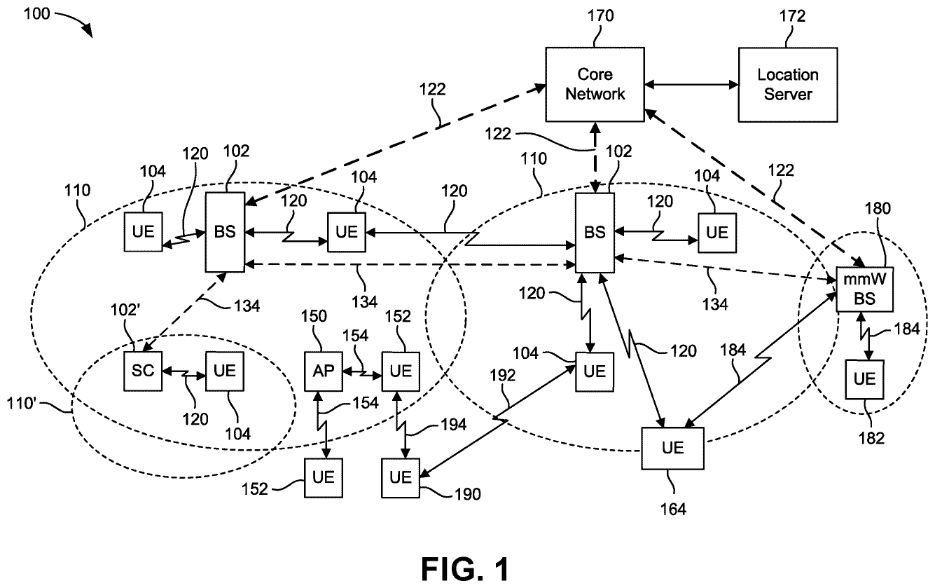

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FRI (from 450 to 6000 Megahertz (MHz)), FR2 (from 24250 to 52600 MHZ), FR3 (above 52600 MHZ), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

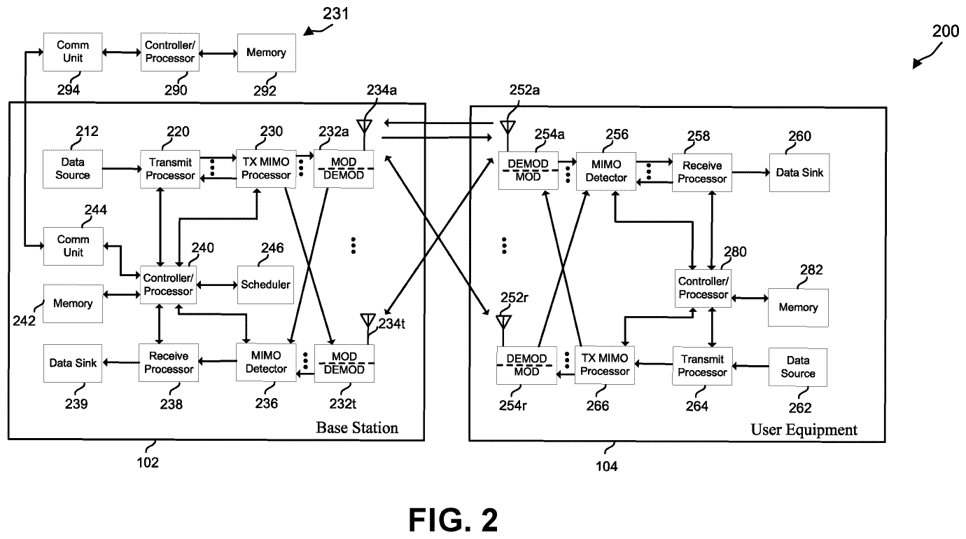

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

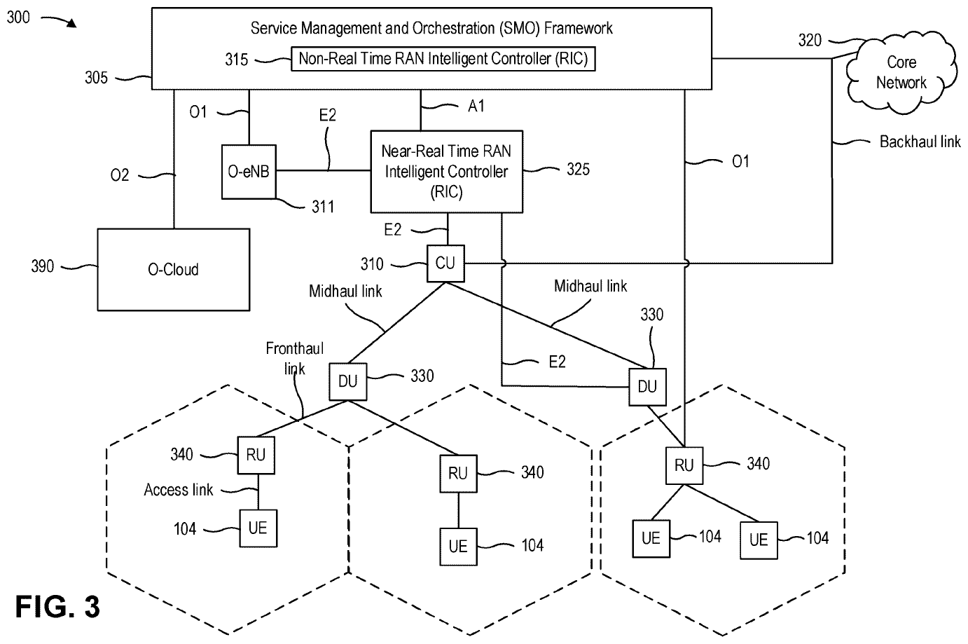

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

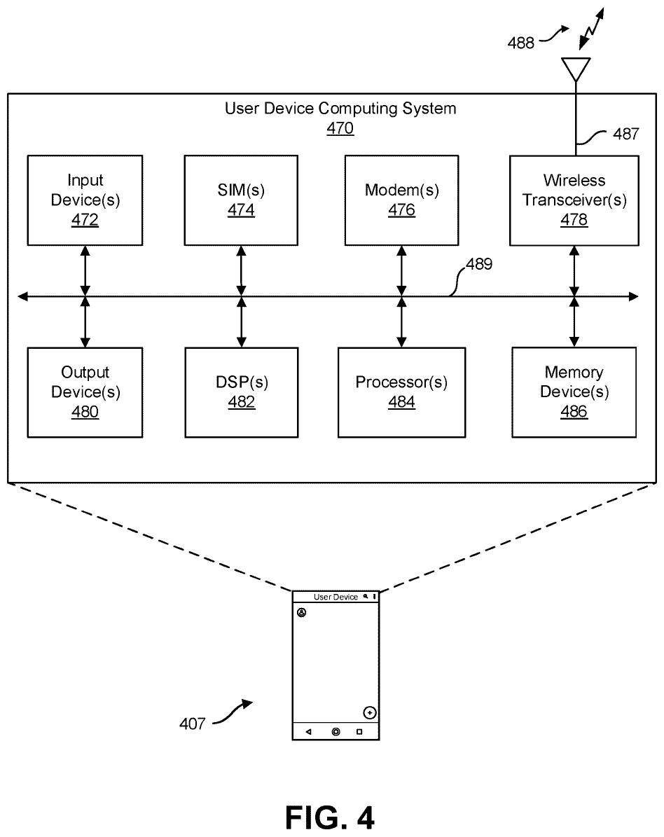

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAS, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

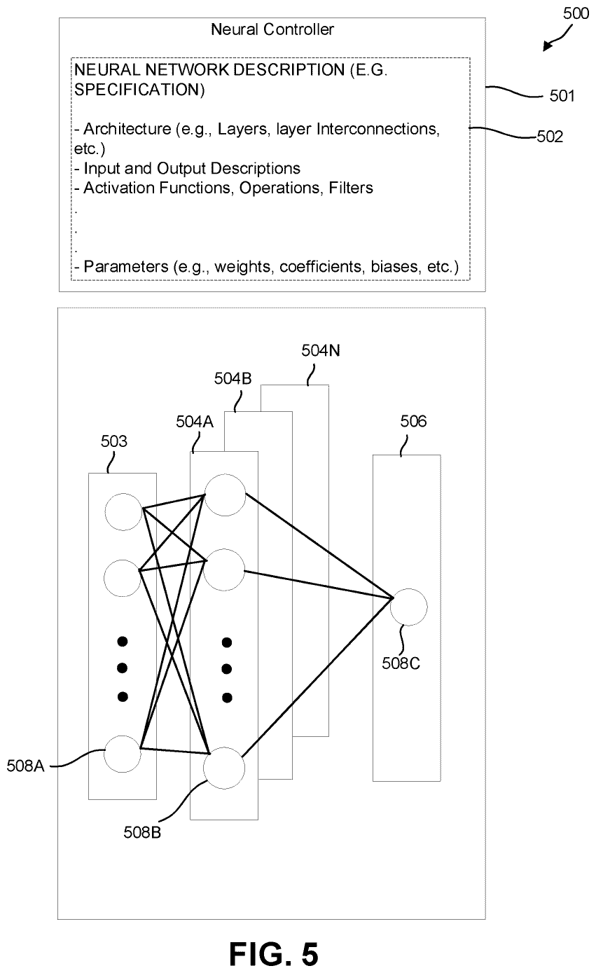

FIG. 5 illustrates an example architecture of a neural network 500 that may be used in accordance with some aspects of the present disclosure. The example architecture of the neural network 500 may be defined by an example neural network description 502 in neural controller 501. The neural network 500 is an example of a machine learning model that can be deployed and implemented at the base station 102, the central unit (CU) 310, the distributed unit (DU) 330, the radio unit (RU) 340, and/or the UE 104. The neural network 500 can be a feedforward neural network or any other known or to-be-developed neural network or machine learning model.

The neural network description 502 can include a full specification of the neural network 500, including the neural architecture shown in FIG. 5. For example, the neural network description 502 can include a description or specification of architecture of the neural network 500 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 500 can reflect the neural architecture defined in the neural network description 502. The neural network 500 can include any suitable neural or deep learning type of network. In some cases, the neural network 500 can include a feed-forward neural network. In other cases, the neural network 500 can include a recurrent neural network, which can have loops that allow information to be carried across nodes while reading in input. The neural network 500 can include any other suitable neural network or machine learning model. One example includes a convolutional neural network (CNN), which includes an input layer and an output layer, with multiple hidden layers between the input and out layers. The hidden layers of a CNN include a series of hidden layers as described below, such as convolutional, nonlinear, pooling (for downsampling), and fully connected layers. In other examples, the neural network 500 can represent any other neural or deep learning network, such as an autoencoder, a deep belief nets (DBNs), a recurrent neural network (RNN), etc.

In the non-limiting example of FIG. 5, the neural network 500 includes an input layer 503, which can receive one or more sets of input data. The input data can be any type of data (e.g., image data, video data, network parameter data, user data, etc.). The neural network 500 can include hidden layers 504A through 504N (collectively “504” hereinafter). The hidden layers 504 can include n number of hidden layers, where n is an integer greater than or equal to one. The n number of hidden layers can include as many layers as needed for a desired processing outcome and/or rendering intent. In one illustrative example, any one of the hidden layers 504 can include data representing one or more of the data provided at the input layer 503. The neural network 500 further includes an output layer 506 that provides an output resulting from the processing performed by hidden layers 504. The output layer 506 can provide output data based on the input data.

In the example of FIG. 5, the neural network 500 is a multi-layer neural network of interconnected nodes. Each node can represent a piece of information. Information associated with the nodes is shared among the different layers and each layer retains information as information is processed. Information can be exchanged between the nodes through node-to-node interconnections between the various layers. The nodes of the input layer 503 can activate a set of nodes in the first hidden layer 504A. For example, as shown, each input node of the input layer 503 is connected to each node of the first hidden layer 504A. The nodes of the hidden layer 504A can transform the information of each input node by applying activation functions to the information. The information derived from the transformation can then be passed to and can activate the nodes of the next hidden layer (e.g., 504B), which can perform their own designated functions. Example functions include convolutional, up-sampling, data transformation, pooling, and/or any other suitable functions. The output of hidden layer (e.g., 504B) can then activate nodes of the next hidden layer (e.g., 504N), and so on. The output of last hidden layer can activate one or more nodes of the output layer 506, at which point an output can be provided. In some cases, while nodes (e.g., nodes 508A, 508B, 508C) in the neural network 500 are shown as having multiple output lines, a node can have a single output and all lines shown as being output from a node can represent the same output value.

In some cases, each node or interconnection between nodes can have a weight that is a set of parameters derived from training the neural network 500. For example, an interconnection between nodes can represent a piece of information learned about the interconnected nodes. The interconnection can have a numeric weight that can be tuned (e.g., based on a training data set), allowing the neural network 500 to be adaptive to inputs and able to learn as more data is processed.

The neural network 500 can be pre-trained to process the features from the data in the input layer 503 using different hidden layers 504 in order to provide the output through the output layer 506. For example, in some cases, the neural network 500 can adjust weights of nodes using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training data until the weights of the layers are accurately tuned (e.g., meet a configurable threshold determined based on experiments and/or empirical studies).

Increasingly ML (e.g., AI) algorithms (e.g., models) are being incorporated into a variety of technologies including wireless telecommunications standards. As ML technologies are a powerful, but still developing area, ML performance may be monitored to ensure expected behavior. In some cases, ML performance may be monitored based on outcomes that result from one or more outputs of the ML model. In some cases, performance of an ML model may refer to how well the one or more outputs of the specific ML model perform against an intended task using a performance metric such as throughout, accuracy of predictions, a combination thereof, and/or other performance metric(s). In some cases, the performance of the ML model may be measured against a similar performance metric for another algorithm, such as a legacy algorithm or another ML algorithm. In some cases, the performance metric may be related to the parameters of a communications link. As an example, performance of an ML model may be evaluated based on throughput using the ML model against a throughput expected of a legacy algorithm. As another example, performance of an ML model may refer to how accurately predictions made by the ML match with actual results. As a more detailed example, where an ML model is used to predict DRX cycles, predictions of the ML model may be monitored based on whether there are transmissions sent to the UE while the UE is in a DRX off state and/or how often the UE exits the DRX off state to monitor for transmissions when there are no transmissions for the UE. Where the ML model performance falls below one or more threshold levels, use of the ML model for predicting and scheduling DRX cycles may be stopped.

In some cases, monitoring ML performance based on outcomes adds a delay as the ML model first generates a prediction, the prediction is used to implement a behavior, outcomes of this behavior monitored, feedback to the outcomes provided, and the feedback used to evaluate the ML performance. In some scenarios, such as for low-latency communications or extended reality applications (e.g., virtual reality, augmented reality, etc.), the delay incurred by outcome-based ML model performance monitoring may be undesirable. In some cases, monitoring data input to the ML model for determining whether to stop using the ML model may provide lower latency and address delay issues in outcome-based ML model performance monitoring.

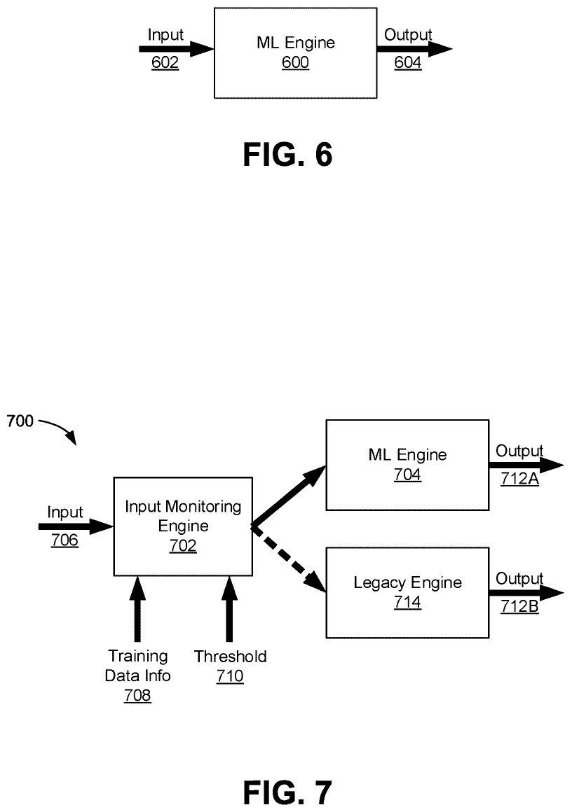

FIG. 6 is a block diagram illustrating an ML engine 600, in accordance with aspects of the present disclosure. As an example, one or more devices in a wireless system may include ML engine 600. In some cases, ML engine 600 may be similar to neural network 500. In this example, ML engine 600 includes three parts, input 602 to the ML engine 600, the ML engine, and the output 604 from the ML engine 600. The input 602 to the ML engine 600 may be data from which the ML engine 600 may use to make predictions or otherwise operate on. As an example, an ML engine 600 configured to select an RF beam may take, as input 602, data regarding current RF conditions, location information, network load, etc. As another example, data related to packets sent to a UE, along with historical packet data may be input 602 to an ML engine 600 configured to predict a DRX schedule for a UE. In some cases, the output 604 may be predictions or other information generated by the ML engine 600 and the output 604 may be used to configure a wireless device, adjust settings, parameters, modes of operations, etc. Continuing the previous examples, the ML engine 600 configured to select an RF beam may output 604 a RF beam or set of RF beams that may be used. Similarly, the ML engine 600 configured to predict a DRX schedule for the UE may output a DRX schedule for the UE.

FIG. 7 is a block diagram illustrating a technique 700 for exiting a first ML model based on observed atypical data, in accordance with aspects of the present disclosure. In this example, an input monitoring engine 702 may be coupled to an ML engine 704. The ML engine 704 may execute a first ML model. In some cases, the first ML model may make predictions for configuring, monitoring, adjusting settings, parameters, modes of operation, etc. of a wireless device and/or wireless connection based on the input data 706. As in FIG. 6, the ML engine 704 may receive input data 706 (via the input monitoring engine 702) to make predictions or otherwise generate output 712A. The output 712A (e.g., of the first ML model executing on the ML engine 704) may be used to configure a wireless device, adjust settings, parameters, modes of operations, etc.

In FIG. 7, the input data 706 for the ML engine 704 may be input to the input monitoring engine 702 before being passed to the ML engine 704. The input monitoring engine 702 may also receive information about training data 708 used to train the first ML model (e.g., information about data used to train the ML model) of the ML engine 704. In some cases, the information about training data 708 may include data used to train the first ML model, or a subset thereof. The data used to train the first ML model may be encrypted, hashed, or otherwise encoded in some cases. In some examples, the information about training data 708 may include information about the data used to train the first ML model, such as statistical information, keywords, distribution information, data ranges, relative relationships between vector values, etc. For example, where the first ML model of ML engine 704 is configured to predict a DRX schedule, certain applications, such as a gaming application, may be associated with specific network traffic characteristic, such as packet size, time domain traffic pattern, etc., and the information about training data 708 may include information describing such statistical information about packet sizes, information about traffic patterns, keywords in the headers, etc. that may indicate the presence of the gaming application. In some cases, a time window for the input data 706 may also be provided. For example, a gNB may configure and/or indicate to a UE one or more time windows corresponding to input data 706. In some cases, the information about the training data 708 may be provided to a wireless device, such as a UE, by another wireless device, such as a gNB. In some cases, the information about the training data 708 may be provided to a wireless device via an online repository or database.

The input monitoring engine 702 may measure an amount of dissimilarity (e.g., difference) between the input data 706 and the information about training data 708 against a threshold 710. In some cases, the threshold 710 may be provided along with the information about the training data 708. If the input monitoring engine 702 determines that the amount of dissimilarity between the input data 706 and the information about training data 708 exceeds threshold 710, the input monitoring engine 702 may stop the use of the first ML model of ML engine 704 and switch to another engine, such as legacy engine 714, to generate output 712B. In some cases, output 712B may be a same type of output as output 712A, but output 712B may be generated without using the first ML model of ML engine 704. As an example, if the ML engine 704 is configured to predict a DRX schedule, the another engine may implement another algorithm used to generate a DRX schedule. This another algorithm may be, in some cases, a legacy algorithm, such as one used in a prior version to generate DRX schedules. In some cases, the another algorithm may be another ML model (e.g., a second ML model). In some cases, an indication that a wireless device has stopped using the first ML model of the ML engine 704 may be sent to another device. For example, where a UE stops using an ML model, such as one which predicts DRX schedules, the UE may transmit an indication to another wireless device, such as to a gNB, indicating that UE is reverting to a legacy DRX schedule. In some cases, the indication that a wireless device has stopped using the first ML model may be implicit. For example, if a gNB stops using the first ML model to predict DRX schedules, the gNB may transmit a new DRX schedule, generated using a legacy algorithm, to a UE.

In some cases, the amount of dissimilarity as between the input data 706 and the information about training data 708 may be based on difference as between a statistical parameter, or a set of statistical parameters, describing the input data 706 and the information about training data 708. Examples of statistical parameter(s) may include mean, variance, higher-order statistical moment, or relation between the input data 706 and the information about the training data 708. In some cases, the amount of dissimilarity may be based on statistics of time variation of observed inputs, Wasserstein distance (e.g., earth-mover's distance or Kantorovich-Rubinstein metric), Kullback-Leibler divergence, Jensen-Shannon divergence, a Kolmogorov-Smirnov test, or any other measure of distance. In some cases, the measure of dissimilarity may be a minimum of a difference between the observed input distribution and a scaled (e.g., multiplied by some factor) version of the training data distributions (e.g., minimum among scaled versions with different scaling factors). In some cases, the measure of dissimilarity may be minimum of the difference between the observed input distribution and a transformed version of the training data distributions (e.g., minimum among transformations with different transform parameters). One or more transformations may be applied. In some examples, the transformation(s) may be a linear transformation (e.g., a shift, translation, scaling, etc.) or a nonlinear transformation. The specific transformation(s) may be implementation specific and may depend, for example, on what is expected of the input. For example, where the input includes a Rayleigh fading channel, the channel coefficients may have complex Gaussian distribution with circular symmetry, which may suggest rotations with a fixed phase should be permitted, and the transformation(s) applied may take such distributions into account. In some cases, types of transformation applied may depend on the structure of the first ML model. For example, some convolutional neural networks are shift (e.g., translated) invariant, which may suggest that shifted or translated (e.g., where vector values are summed with a value, another vector, etc.) versions of the training input should be still considered typical.

In some cases, the measure of similarly may be based on output from another ML model (e.g., a similarity measuring ML model). In some cases, this another ML model may be a relatively simpler ML model (as compared to an ML model of ML engine 704), to help avoid additional computational overhead/complexity. In some cases, relatively simpler another ML model may be used as the accuracy of the another ML model can be relatively lower as compared to the ML model used in ML engine 704. The accuracy of the another ML model may be lower because the consequences when the another ML model outputs an inaccurate result may be relatively less as compared to the ML model used in ML engine 704. For example, if the another ML model generates an inaccurate results, such as a false positive, the consequence may just be that use of the ML model in ML engine 704 is stopped and fallback, for example, to a legacy engine 714 may occur and this fallback may be preferable as compared to inaccurate results from the ML model used in ML engine 704. In some cases, the another ML model may be a generative adversarial network (GAN). Generally, a GAN may be used to generate data that is similar to target data. A GAN may be used to find a minimum (or local minimum) of dissimilarity of the observed input and a class of transformations on the training input (e.g., before comparing that minimum to the threshold 710). In some cases, the class of transformations may be predefined.

In some cases, after input monitoring engine 702 may stop the use of the first ML model of the ML engine 704 and switch to another ML model, such as a second ML model which performs a similar functionality to the first ML model. For example, where the first ML model is configured to predict DRX schedules, the second ML model may also be configured to predict DRX schedules. However, different ML models may have a different tolerance for different types of data. For example, the first ML model may be trained to make highly accurate predictions given a specific environment (e.g., type of input data 706) and may produce relatively less accurate predictions given a change in environment (e.g., when the input data 706 varies). The second ML model may be trained to be more robust to changes in the environment, but may make relatively less accurate predictions for specific environments, such as environments in which the first ML model is configured to make accurate predictions in. In such cases, the input monitoring engine 702 may receive information about the training data 708 corresponding to the first ML model and information about the training data 708 corresponding to the second ML model. The input monitoring engine 702 may compare the similarity measure of the input data 706 (e.g., for a past time interval) to the information about the training data 708 associated with the first ML model and the information about the training data 708 associated with the second ML model and select the ML model with best similarity (e.g., in comparison to the corresponding threshold on similarity/dissimilarity). In some cases, different ML models may have different thresholds of input dissimilarity for triggering exit. For example, where the first ML model may be trained to make highly accurate predictions given a specific environment, the first ML model may be associated (e.g., configured with) a relatively lower dissimilarity/similarity threshold 710 as compared to the second ML model, which may be more robust to varying environments.

In some cases, stopping the use of the first ML model based on a similarity/dissimilarity threshold 710 (e.g., atypical data) as applied to input data 706 may be applied in conjunction with ML model performance monitoring. As indicated above, ML performance may be monitored based on outcomes that result from output of the ML model. In some cases, ML performance monitoring may be integrated with input data monitoring by using the ML performance monitoring to modify the threshold 710. That is, the threshold 710 value may be adjusted based on the performance of the first ML model. For example, a lower threshold 710 of dissimilarity may be applied based on a relatively worse past performance. As an example, where the first ML model predicts which RF beams to use, different thresholds 710 may be applied based on a prediction error over a past time interval. Where there have not been any prediction errors in the past time interval, a relatively larger threshold 710 (e.g., greater dissimilarity between the input data 706 and the information about training data 708) may be applied. If a percentage of prediction errors is below, for example 10%, then a smaller threshold 710 may be applied. If the percentage of prediction errors is above, for example 10%, then an even smaller threshold 710 may be applied. In some cases, if the percentage error is above, for example, another percentage, then use of the first ML model stopped based on the performance monitoring.

As indicated above, techniques for stopping use of a first ML based on atypical input data may be performed on a variety of wireless devices, including user side wireless devices, such as a UE, and network side wireless devices, such as eNB, gNB, etc. In some cases, where a client side wireless device, can stop the use of the first ML based on atypical input data, the client side wireless device may feedback information to the network. In some cases, this feedback information may indicate, for example, that the UE is using the first ML model, that the UE has stopped using the first ML model, and in some cases, why the UE has stopped using the first ML model.

In some cases, the client side wireless device may also provide feedback regarding the measured similarity/dissimilarity of the input data 706 to the information about training data 708. In some cases, the feedback regarding the measured similarity/dissimilarity may be a part of a periodic and/or semi-periodic feedback about ML model performance. For example, the UE may be configured to provide periodic and/or semi-periodic feedback regarding ML model performance in general and the feedback regarding the measured similarity/dissimilarity may be included in such feedback. Resources for the feedback may be configured for the UE by the gNB. For example, the gNB may transmit a downlink control information message, resource information for providing feedback (e.g., measured similarity/dissimilarity information and/or feedback regarding ML model performance in general). The UE may transmit feedback to the gNB via, for example, an uplink (UL) medium access control (MAC) control element (MAC CE), as UL data on a physical uplink shared channel (PUSCH), as uplink control information (UCI) on PUSCH, or on physical uplink control channel (PUCCH).

In some cases, after stopping the use of a first ML model based on dissimilarity between the input data 706 and the information about training data 708, use of the first ML model may be resumed. In some cases, use of the first ML model may be resumed, for example, if the dissimilarity measure between the input data 706 (in a past time interval) and the information about training data 708 (or an updated version of it received from network) falls below a certain threshold value (e.g., a resumption threshold value). In some cases, the resumption threshold value may be different from the threshold for stopping the use of the first ML model. For example, the resumption threshold value may be lower (e.g., greater similarity between the input data 706 and the information about training data 708) that the threshold for stopping the use of the first ML model to help induce a hysteresis type behavior to avoid excessive switching between using the first ML model and stopping the use of the first ML model.

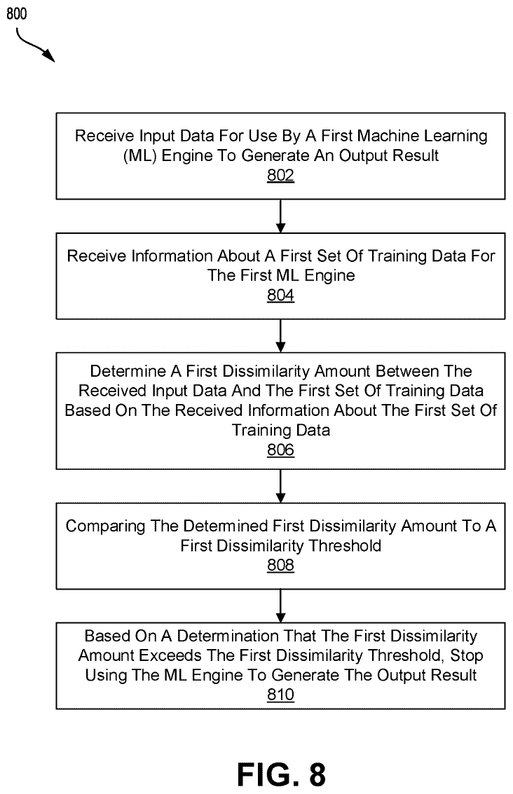

FIG. 8 is a flow diagram illustrating a process 800 for exiting a first ML model based on observed atypical data, in accordance with aspects of the present disclosure. In some cases, the process 800 for exiting the first ML model may be performed, for example, by an input monitoring engine 702. At operation 802, the process 800 can include receiving input data for use by a first machine learning (ML) engine to generate an output result. At operation 804, the process 800 can include receiving information associated with a first set of training data for the first ML engine. In some cases, the information associated with the first set of training data comprises at least a portion of the first set of training data. In some cases, the information associated with the first set of training data comprises one or more statistical parameters.

At operation 806, the process 800 can include determining a first dissimilarity amount between the received input data and the first set of training data based on the received information associated with the first set of training data. In some cases, first dissimilarity amount is based on one or more statistical parameters.

At operation 808, the process 800 can include determining whether to continue using the first ML engine to generate the output result based on a comparison of the determined first dissimilarity amount to a first dissimilarity threshold. In some cases, the process 800 can also include stopping the use of the first ML engine to generate the output result based on a determination that the first dissimilarity amount exceeds the first dissimilarity threshold. In some cases, the output result of the first ML engine is for determining a parameter associated with an apparatus.

In some cases, the process 800 can also include determining the parameter using a legacy algorithm based on the determination that the first dissimilarity amount exceeds the first dissimilarity threshold. In some cases, the process 800 can also include switching to a second ML engine to generate the output result based on the determination that the first dissimilarity amount exceeds the first dissimilarity threshold. In some cases, the process 800 can also include receiving information associated with a second set of training data for the second ML engine, determining a second dissimilarity amount between the received input data and the second set of training data based on the received information associated with the second set of training data, and switching to a second ML engine based on a comparison of the second dissimilarity amount and a second dissimilarity threshold, the second dissimilarity threshold associated with the second ML engine.

In some cases, the process 800 can also include using the first ML engine to generate the output result based on the input data, based on a determination that the first dissimilarity amount is within the first dissimilarity threshold. In some cases, the process 800 can also include applying a transformation to one of the input data or the information associated with the first set of training data. In some cases, the process 800 can also include determining the first dissimilarity amount using an ML model. In some cases, the process 800 can also include determining a configuration parameter based on the output result; and transmitting an indication of the configuration parameter to a user device. In some cases, the process 800 can also include determining a configuration parameter based on the output result, and transmitting an indication of the configuration parameter to a network device.

In some examples, the processes described herein (e.g., process 800 and/or other process described herein) may be performed by a computing device or apparatus (e.g., a UE or a base station). In another example, the process 800 may be performed by the UE 104 of FIG. 1. In another example, the process 800 may be performed by a base station 102 of FIG. 1

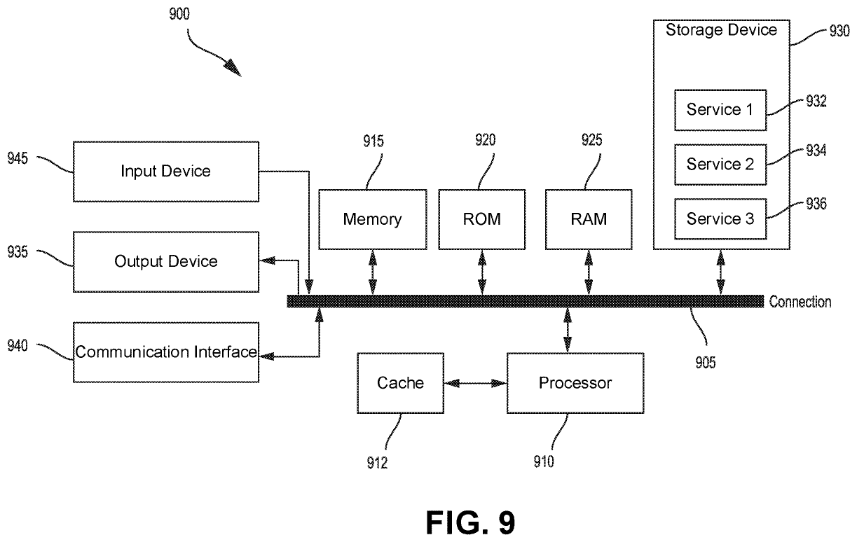

FIG. 9 is a diagram illustrating an example of a system for implementing certain aspects of the present technology. In particular, FIG. 9 illustrates an example of computing system 900, which may be for example any computing device making up internal computing system, a remote computing system, a camera, or any component thereof in which the components of the system are in communication with each other using connection 905. Connection 905 may be a physical connection using a bus, or a direct connection into processor 910, such as in a chipset architecture. Connection 905 may also be a virtual connection, networked connection, or logical connection.

In some embodiments, computing system 900 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 900 includes at least one processing unit (CPU or processor) 910 and connection 905 that communicatively couples various system components including system memory 915, such as read-only memory (ROM) 920 and random access memory (RAM) 925 to processor 910. Computing system 900 may include a cache 912 of high-speed memory connected directly with, in close proximity to, or integrated as part of processor 910.

Processor 910 may include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which may represent any number of input mechanisms, such as a microphone for speech, a touch-sensitive screen for gesture or graphical input, keyboard, mouse, motion input, speech, etc. Computing system 900 may also include output device 935, which may be one or more of a number of output mechanisms. In some instances, multimodal systems may enable a user to provide multiple types of input/output to communicate with computing system 900.

Computing system 900 may include communications interface 940, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 may include software services, servers, services, etc., that when the code that defines such software is executed by the processor 910, it causes the system to perform a function. In some embodiments, a hardware service that performs a particular function may include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative aspects of the disclosure include:

Aspect 1. An apparatus for wireless communications, comprising: at least one memory; and at least one processor coupled to the memory and configured to: receive input data for use by a first machine learning (ML) engine to generate an output result; receive information associated with a first set of training data for the first ML engine; determine a first dissimilarity amount between the received input data and the first set of training data based on the received information associated with the first set of training data; and determine whether to continue using the first ML engine to generate the output result based on a comparison of the determined first dissimilarity amount to a first dissimilarity threshold.

Aspect 2. The apparatus of claim 1, wherein the at least one processor is further configured to, based on a determination that the first dissimilarity amount exceeds the first dissimilarity threshold, stop using the first ML engine to generate the output result.

Aspect 3. The apparatus of claim 2, wherein the output result of the first ML engine is for determining a parameter associated with the apparatus and wherein the at least one processor is further configured to determine the parameter using a legacy algorithm based on the determination that the first dissimilarity amount exceeds the first dissimilarity threshold.

Aspect 4. The apparatus of claim 2, wherein the at least one processor is further configured to switch to a second ML engine to generate the output result based on the determination that the first dissimilarity amount exceeds the first dissimilarity threshold.

Aspect 5. The apparatus of claim 4, wherein the at least one processor is further configured to: receive information associated with a second set of training data for the second ML engine; determine a second dissimilarity amount between the received input data and the second set of training data based on the received information associated with the second set of training data; and switch to a second ML engine based on a comparison of the second dissimilarity amount and a second dissimilarity threshold, the second dissimilarity threshold associated with the second ML engine.

Aspect 6. The apparatus of claim 1, wherein the at least one processor is further configured to, based on a determination that the first dissimilarity amount is within the first dissimilarity threshold, use the first ML engine to generate the output result based on the input data.

Aspect 7. The apparatus of claim 1, wherein the information associated with the first set of training data comprises at least a portion of the first set of training data.

Aspect 8. The apparatus of claim 1, wherein the information associated with the first set of training data comprises one or more statistical parameters.

Aspect 9. The apparatus of claim 1, wherein the first dissimilarity amount is based on one or more statistical parameters.

Aspect 10. The apparatus of claim 1, wherein the at least one processor is further configured to apply a transformation to one of the input data or the information associated with the first set of training data.

Aspect 11. The apparatus of claim 1, wherein the at least one processor is further configured to determine the first dissimilarity amount using an ML model.

Aspect 12. The apparatus of claim 1, wherein the apparatus comprises a network device, and wherein the at least one processor is further configured to: determine a configuration parameter based on the output result; and transmit an indication of the configuration parameter to a user device.

Aspect 13. The apparatus of claim 1, wherein the apparatus comprises a user device, and wherein the at least one processor is further configured to: determine a configuration parameter based on the output result; and transmit an indication of the configuration parameter to a network device.

Aspect 14. A method for wireless communications, comprising: receiving input data for use by a first machine learning (ML) engine to generate an output result; receiving information associated with a first set of training data for the first ML engine; determining a first dissimilarity amount between the received input data and the first set of training data based on the received information associated with the first set of training data; and determining whether to continue using the first ML engine to generate the output result based on a comparison of the determined first dissimilarity amount to a first dissimilarity threshold.

Aspect 15. The method of claim 14, further comprising stop using the first ML engine to generate the output result based on a determination that the first dissimilarity amount exceeds the first dissimilarity threshold.

Aspect 16. The method of claim 15, wherein the output result of the first ML engine is for determining a parameter associated with an apparatus, and further comprising determining the parameter using a legacy algorithm based on the determination that the first dissimilarity amount exceeds the first dissimilarity threshold.

Aspect 17. The method of claim 15, further comprising switching to a second ML engine to generate the output result based on the determination that the first dissimilarity amount exceeds the first dissimilarity threshold.

Aspect 18. The method of claim 17, further comprising: receiving information associated with a second set of training data for the second ML engine; determining a second dissimilarity amount between the received input data and the second set of training data based on the received information associated with the second set of training data; and switching to a second ML engine based on a comparison of the second dissimilarity amount and a second dissimilarity threshold, the second dissimilarity threshold associated with the second ML engine.

Aspect 19. The method of claim 14, further comprising using the first ML engine to generate the output result based on the input data, based on a determination that the first dissimilarity amount is within the first dissimilarity threshold.

Aspect 20. The method of claim 14, wherein the information associated with the first set of training data comprises at least a portion of the first set of training data.

Aspect 21. The method of claim 14, wherein the information associated with the first set of training data comprises one or more statistical parameters.

Aspect 22. The method of claim 14, wherein the first dissimilarity amount is based on one or more statistical parameters.

Aspect 23. The method of claim 14, further comprising applying a transformation to one of the input data or the information associated with the first set of training data.

Aspect 24. The method of claim 14, further comprising determining the first dissimilarity amount using an ML model.

Aspect 25. The method of claim 14, further comprising determining a configuration parameter based on the output result; and transmitting an indication of the configuration parameter to a user device.

Aspect 26. The method of claim 14, further comprising determining a configuration parameter based on the output result; and transmitting an indication of the configuration parameter to a network device.

Aspect 27. A non-transitory computer-readable storage medium comprising instructions stored thereon which, when executed by at least one processor, causes the at least one processor to: receive input data for use by a first machine learning (ML) engine to generate an output result; receive information associated with a first set of training data for the first ML engine; determine a first dissimilarity amount between the received input data and the first set of training data based on the received information associated with the first set of training data; and determine whether to continue using the first ML engine to generate the output result based on a comparison of the determined first dissimilarity amount to a first dissimilarity threshold.

Aspect 28. The non-transitory computer-readable storage medium of claim 27, wherein the instructions further cause the at least one processor to, based on a determination that the first dissimilarity amount exceeds the first dissimilarity threshold, stop using the first ML engine to generate the output result.

Aspect 29. The non-transitory computer-readable storage medium of claim 28, wherein the output result of the first ML engine is for determining a parameter associated with the apparatus and wherein the instructions further cause the at least one processor to determine the parameter using a legacy algorithm based on the determination that the first dissimilarity amount exceeds the first dissimilarity threshold.

Aspect 30. The non-transitory computer-readable storage medium of claim 28, wherein the instructions further cause the at least one processor to switch to a second ML engine to generate the output result based on the determination that the first dissimilarity amount exceeds the first dissimilarity threshold.

Aspect 31. The non-transitory computer-readable storage medium of claim 30, wherein the instructions further cause the at least one processor to: receive information associated with a second set of training data for the second ML engine; determine a second dissimilarity amount between the received input data and the second set of training data based on the received information associated with the second set of training data; and switch to a second ML engine based on a comparison of the second dissimilarity amount and a second dissimilarity threshold, the second dissimilarity threshold associated with the second ML engine.

Aspect 32. The non-transitory computer-readable storage medium of claim 27, wherein the instructions further cause the at least one processor to, based on a determination that the first dissimilarity amount is within the first dissimilarity threshold, use the first ML engine to generate the output result based on the input data.

Aspect 33. The non-transitory computer-readable storage medium of claim 27, wherein the information associated with the first set of training data comprises at least a portion of the first set of training data.

Aspect 34. The non-transitory computer-readable storage medium of claim 27, wherein the information associated with the first set of training data comprises one or more statistical parameters.

Aspect 35. The non-transitory computer-readable storage medium of claim 27, wherein the first dissimilarity amount is based on one or more statistical parameters.

Aspect 36. The non-transitory computer-readable storage medium of claim 27, wherein the instructions further cause the at least one processor to apply a transformation to one of the input data or the information associated with the first set of training data.

Aspect 37. The non-transitory computer-readable storage medium of claim 27, wherein the instructions further cause the at least one processor to determine the first dissimilarity amount using an ML model.

Aspect 38. The non-transitory computer-readable storage medium of claim 27, wherein the apparatus comprises a network device, and wherein the instructions further cause the at least one processor to: determine a configuration parameter based on the output result; and transmit an indication of the configuration parameter to a user device.

Aspect 39. The non-transitory computer-readable storage medium of claim 27, wherein the apparatus comprises a user device, and wherein the instructions further cause the at least one processor to: determine a configuration parameter based on the output result; and transmit an indication of the configuration parameter to a network device.

Aspect 40. An apparatus for wireless communications comprising one or more means for performing operations according to any of claims 14 to 26.

1. An apparatus for wireless communications, comprising:
at least one memory; and
at least one processor coupled to the at least one memory and configured to:
receive input data for use by a first machine learning (ML) engine to generate an output result;
receive information associated with a first set of training data for the first ML engine;
determine a first dissimilarity amount between the received input data and the first set of training data based on the received information associated with the first set of training data; and
determine whether to continue using the first ML engine to generate the output result based on a comparison of the determined first dissimilarity amount to a first dissimilarity threshold.

2. The apparatus of claim 1, wherein the at least one processor is further configured to, based on a determination that the first dissimilarity amount exceeds the first dissimilarity threshold, stop using the first ML engine to generate the output result.

3. The apparatus of claim 2, wherein the output result of the first ML engine is for determining a parameter associated with the apparatus and wherein the at least one processor is further configured to determine the parameter using a legacy algorithm based on the determination that the first dissimilarity amount exceeds the first dissimilarity threshold.

4. The apparatus of claim 2, wherein the at least one processor is further configured to switch to a second ML engine to generate the output result based on the determination that the first dissimilarity amount exceeds the first dissimilarity threshold.

5. The apparatus of claim 4, wherein the at least one processor is further configured to:
receive information associated with a second set of training data for the second ML engine;
determine a second dissimilarity amount between the received input data and the second set of training data based on the received information associated with the second set of training data; and
switch to a second ML engine based on a comparison of the second dissimilarity amount and a second dissimilarity threshold, the second dissimilarity threshold associated with the second ML engine.

6. The apparatus of claim 1, wherein the at least one processor is further configured to, based on a determination that the first dissimilarity amount is within the first dissimilarity threshold, use the first ML engine to generate the output result based on the input data.

7. The apparatus of claim 1, wherein the information associated with the first set of training data comprises at least a portion of the first set of training data.

8. The apparatus of claim 1, wherein the information associated with the first set of training data comprises one or more statistical parameters.

9. The apparatus of claim 1, wherein the first dissimilarity amount is based on one or more statistical parameters.

10. The apparatus of claim 1, wherein the at least one processor is further configured to apply a transformation to one of the input data or the information associated with the first set of training data.

11. The apparatus of claim 1, wherein the at least one processor is further configured to determine the first dissimilarity amount using an ML model.

12. The apparatus of claim 1, wherein the apparatus comprises a network device, and wherein the at least one processor is further configured to:
determine a configuration parameter based on the output result; and
transmit an indication of the configuration parameter to a user device.

13. The apparatus of claim 1, wherein the apparatus comprises a user device, and wherein the at least one processor is further configured to:
determine a configuration parameter based on the output result; and
transmit an indication of the configuration parameter to a network device.

14. A method for wireless communications, comprising:
receiving input data for use by a first machine learning (ML) engine to generate an output result;
receiving information associated with a first set of training data for the first ML engine;
determining a first dissimilarity amount between the received input data and the first set of training data based on the received information associated with the first set of training data; and
determining whether to continue using the first ML engine to generate the output result based on a comparison of the determined first dissimilarity amount to a first dissimilarity threshold.

15. The method of claim 14, further comprising stopping use of the first ML engine to generate the output result based on a determination that the first dissimilarity amount exceeds the first dissimilarity threshold.

16. The method of claim 15, wherein the output result of the first ML engine is for determining a parameter associated with an apparatus, and further comprising determining the parameter using a legacy algorithm based on the determination that the first dissimilarity amount exceeds the first dissimilarity threshold.

17. The method of claim 15, further comprising switching to a second ML engine to generate the output result based on the determination that the first dissimilarity amount exceeds the first dissimilarity threshold.

18. The method of claim 17, further comprising:
receiving information associated with a second set of training data for the second ML engine;
determining a second dissimilarity amount between the received input data and the second set of training data based on the received information associated with the second set of training data; and
switching to a second ML engine based on a comparison of the second dissimilarity amount and a second dissimilarity threshold, the second dissimilarity threshold associated with the second ML engine.

19. The method of claim 14, wherein the information associated with the first set of training data comprises at least a portion of the first set of training data.

20. The method of claim 14, wherein the information associated with the first set of training data comprises one or more statistical parameters.

21. The method of claim 14, wherein the first dissimilarity amount is based on one or more statistical parameters.

22. The method of claim 14, further comprising applying a transformation to one of the input data or the information associated with the first set of training data.

23. The method of claim 14, further comprising:
determining a configuration parameter based on the output result; and
transmitting an indication of the configuration parameter to a user device.

24. The method of claim 15, further comprising:
determining a configuration parameter based on the output result; and
transmitting an indication of the configuration parameter to a network device.

25. A non-transitory computer-readable storage medium comprising instructions stored thereon which, when executed by at least one processor, causes the at least one processor to:
receive input data for use by a first machine learning (ML) engine to generate an output result;
receive information associated with a first set of training data for the first ML engine;
determine a first dissimilarity amount between the received input data and the first set of training data based on the received information associated with the first set of training data; and
determine whether to continue using the first ML engine to generate the output result based on a comparison of the determined first dissimilarity amount to a first dissimilarity threshold.

26. The non-transitory computer-readable storage medium of claim 25, wherein the instructions further cause the at least one processor to, based on a determination that the first dissimilarity amount exceeds the first dissimilarity threshold, stop using the first ML engine to generate the output result.

27. The non-transitory computer-readable storage medium of claim 26, wherein the output result of the first ML engine is for determining a parameter associated with an apparatus and wherein the instructions further cause the at least one processor to determine the parameter using a legacy algorithm based on the determination that the first dissimilarity amount exceeds the first dissimilarity threshold.

28. The non-transitory computer-readable storage medium of claim 26, wherein the instructions further cause the at least one processor to switch to a second ML engine to generate the output result based on the determination that the first dissimilarity amount exceeds the first dissimilarity threshold.

29. The non-transitory computer-readable storage medium of claim 25, wherein the instructions further cause the at least one processor to:
determine a configuration parameter based on the output result; and
transmit an indication of the configuration parameter to a user device.

30. The non-transitory computer-readable storage medium of claim 25, wherein the instructions further cause the at least one processor to:
determine a configuration parameter based on the output result; and
transmit an indication of the configuration parameter to a network device.

31. (canceled)
